(19) United States
(12) Patent Application Publication
(10) Pub. No.: US 2023/0037579 A1
(43) Pub. Date: Feb. 9, 2023

(54) STEEL STRIP NOTCHING METHOD, COLD ROLLING METHOD, AND METHOD FOR PRODUCING COLD-ROLLED STEEL STRIP

(71) Applicant: JFE STEEL CORPORATION, Tokyo (JP)

(72) Inventors: Yuu NAGAI, Tokyo (JP); Ryuichi SUEHIRO, Tokyo (JP); Ryota HOSOYA, Tokyo (JP)

(73) Assignee: JFE STEEL CORPORATION, Tokyo (JP)

(21) Appl. No.: 17/778,704

(22) PCT Filed: Nov. 10, 2020
(86) PCT No.: PCT/JP2020/041809

§ 371 Date: May 20, 2022

(30) Foreign Application Priority Data
Nov. 25, 2019 (JP) 2019-212248

(51) Int. Cl. B21B 15/00; B21B 1/22

(52) U.S. Cl. CPC B21B 15/0007; B21B 15/0085; B21B 1/22; B21B 2001/221; B21B 2015/0014; B21B 2015/0021; B21B 2015/0092

(57) ABSTRACT

A steel strip notching method including forming a notch at an end portion of a joint in a strip width direction formed by joining a trailing end of a preceding steel strip to a leading end of a succeeding steel strip, and removing a region of the notch through grinding by cutting the region with a rotary grinding tool by feeding the tool in the strip width direction, feeding the tool in a strip vertical direction at a feed rate within a predetermined range with respect to a feed rate of the tool in the strip width direction, giving a predetermined feed amount in a strip longitudinal direction while feeding the tool by a predetermined feed amount in the strip width direction simultaneously with feeding the tool in the strip vertical direction, and cutting the region while oscillating the tool in the strip longitudinal direction.

### TECHNICAL FIELD

This application relates to a steel strip notching method, a cold rolling method, and a method for producing a cold-rolled steel strip.

### BACKGROUND

A steel strip cold rolling process generally involves joining a trailing end of a preceding material (preceding steel strip) to a leading end of a succeeding material (succeeding steel strip) and continuously supplying the resulting strip to a cold rolling line. This enables continuous rolling of a coil and improves productivity of the line. Also, since the steel strip can be rolled under tension throughout its entire length, the sheet thickness and shape can be controlled with high accuracy even at the head and tail ends of the steel strip and this leads to improved yields.

Steel strips are joined by using a welding technique, such as flash-butt welding or laser welding. With either of the welding techniques, it is inevitable that an end portion of a joint (weld) in a strip width direction (which may be referred to as a widthwise end portion of a joint) between the preceding material and the succeeding material will have a widthwise stepped portion formed due to, for example, a difference in strip width or positional displacement between the preceding material and the succeeding material. The widthwise stepped portion, which has a protruding corner of the steel strip, may be caught between rolls during the rolling process and this may damage the facility. Also, since welding is inadequate at the widthwise end portion of the joint, the lack of welding strength increases the risk of fracture of the joint during rolling. If the joint is fractured, the production line needs to be stopped for dealing with the fractured strip, and this leads to a lower operation rate. Moreover, if work rolls are damaged at the time of fracture, the work rolls need to be replaced and this deteriorates the consumption rate. Particularly in recent years, for the purposes of providing lightweight components and improved characteristics, the gauges of cold-rolled steel strips have been reduced. The resulting increase in rolling reduction ratio leads to an increased joint fracture rate.

Accordingly, rolling is often preceded by notching which involves forming notches (cutouts) at widthwise end portions of a joint. The notching makes it possible to remove a protruding corner of the steel strip at the widthwise stepped portion and an incomplete weld formed as a result of inadequate welding, and thus to prevent fracture of the joint during rolling. Examples of a general notching method include mechanical shearing that forms, at a widthwise end portion of a joint, a semi-circular notch having no protruding corner (see, e.g., FIG. 4 in Patent Literature 1). However, the outer edge of this semi-circular notch has a uniform curvature. Since the width of the steel strip is minimized at the joint, the maximum stress is generated at the joint after the notching. To solve this problem, Patent Literature 1 proposes a method in which a notch is formed into a substantially isosceles trapezoidal shape so that the maximum stress is generated outside the joint.

However, with the notching method described in Patent Literature 1, fracture of the joint during rolling cannot be fully reduced in cold rolling of brittle materials or high-alloy materials, such as silicon steel sheets or high tensile strength steel sheets.

Patent Literature 2 describes a steel strip notching method in which after first notches are formed by shearing at both edges of a joint in a strip width direction between a trailing end of a preceding steel strip and a leading end of a succeeding steel strip, second notches are formed by grinding end faces of both the edges of the joint in the strip width direction. The notching method described in Patent Literature 2 exhibits a high suppressing effect on fracture of the joint during rolling, even in cold rolling of brittle materials or high-alloy materials, such as silicon steel sheets or high tensile strength steel sheets.

In the notching method described in Patent Literature 2, however, grinding the end faces of both the edges of the joint in the strip width direction may cause significant chatter vibration. Also, increased wear of the grinding tool may lead to a considerable decrease in tool life.

### CITATION LIST

### Patent Literature

PTL 1: Japanese Unexamined Patent Application Publication No. 2014-50853
PTL 2: Japanese Unexamined Patent Application Publication No. 2017-144467

### SUMMARY

### Technical Problem

The disclosed embodiments provide a steel strip notching method that exhibits a high suppressing effect on chatter vibration and can reduce a decrease in tool life when forming a notch at an end portion of a joint in a strip width direction is followed by removing at least part of a region of the notch, particularly an end portion of the joint in the strip width direction, through grinding.

The disclosed embodiments also provide a cold rolling method using the steel strip notching method, and a method for producing a cold-rolled steel strip using the cold rolling method.

### Solution to Problem

The disclosed embodiments provide a technique in which, after a notch is formed at an end portion of a joint in a strip width direction to solve the problems described above, at least part of a region of the notch, particularly an end portion of the joint in the strip width direction, is removed by grinding using a rotary grinding tool, such as a rotary burr.

The background leading to the disclosed embodiments will now be described. Through observation of end portions of a joint in a strip width direction (which may be referred to as widthwise end portions of a joint) after cold rolling preceded by notching of the widthwise end portions of the joint, the inventors found, as shown in FIG. 4, that there was a crack X with a length of about 2 mm in the strip width direction, at a widthwise end portion of a joint 3 between a preceding steel strip 1 and a succeeding steel strip 2. The crack X often develops into fracture of the joint. The inventors found out that the crack X was formed because the widthwise end portion of the joint, obtained after notching, was work-hardened as a result of the notching. The mechanism is as follows. First, when a notch is formed at a widthwise end portion of a joint, the widthwise end portion of the joint, obtained after the notching, is work-hardened. This work-hardened region (work-hardened portion) is more resistant to deformation than the other region. The work-hardened portion cannot be deformed during rolling and develops into the crack X.

The inventors thus came up with an idea that fracture of the joint would be reduced by simply removing the work-hardened portion formed at the widthwise end portion of the joint after notching. Also, it was determined that in the disclosed embodiments, the work-hardened portion was to be removed by grinding. Grinding enables removal of only the work-hardened portion formed by notching, without causing another work hardening at the widthwise end portion of the joint after the grinding.

It was also determined that a rotary grinding tool was to be used for grinding in the disclosed embodiments. In particular, when processing is performed under optimal conditions by using a rotary burr as the rotary grinding tool, the occurrence of chatter vibration during grinding can be more effectively suppressed and a work-hardened portion formed after notching can be removed while deterioration of grindability caused by clogging and wear of the rotary burr (tool edge) can be minimized.

The disclosed embodiments include the following features:

[1] A steel strip notching method includes forming a notch at an end portion of a joint in a strip width direction formed by joining a trailing end of a preceding steel strip to a leading end of a succeeding steel strip, and removing at least part of a region of the notch through grinding. At least the part of the region of the notch to be removed by the grinding is removed by grinding which involves;

cutting the region with a rotary grinding tool by feeding the rotary grinding tool in the strip width direction, feeding the rotary grinding tool in a strip vertical direction at a feed rate within a predetermined range with respect to a feed rate of the rotary grinding tool in the strip width direction, giving a predetermined feed amount in a strip longitudinal direction while feeding the rotary grinding tool by a predetermined feed amount in the strip width direction simultaneously with feeding the rotary grinding tool in the strip vertical direction, and cutting the region while oscillating the rotary grinding tool in the strip longitudinal direction.

[2] In the steel strip notching method according to [1], the rotary grinding tool is a rotary burr, and the rotary burr is fed in the strip vertical direction at a feed rate 0.3 to 10.0 times a feed rate of the rotary burr in the strip width direction.

[3] In the steel strip notching method according to [1] or [2], the rotary grinding tool is a rotary burr, and a feed amount greater than or equal to 5.0% of a diameter of the rotary burr is given in the strip longitudinal direction while the rotary burr is fed in the strip width direction by a predetermined feed amount less than or equal to 1.0% of the diameter of the rotary burr.

[4] A cold rolling method includes cold rolling a steel strip notched by the steel strip notching method according to any one of [1] to [3].

[5] A method for producing a cold-rolled steel strip includes producing a cold-rolled steel strip by using the cold rolling method according to [4].

### Advantageous Effects

A steel strip notching method according to the disclosed embodiments can provide a steel strip notching method that exhibits a high suppressing effect on chatter vibration and can reduce a decrease in tool life when forming a notch at an end portion of a joint in a strip width direction is followed by removing, through grinding, at least part of a region of the notch, particularly an end portion of the joint in the strip width direction formed after the notching.

In the disclosed embodiments, a work-hardened portion, which may cause fracture of the joint, is removed by grinding. Therefore, even in the case of rolling of a brittle material or a high-alloy material, such as a silicon steel sheet or a high tensile strength steel sheet containing a high proportion of Si or Mn, fracture of the joint (or weld) can be reduced. Moreover, by applying the method of the disclosed embodiments, using a rotary grinding tool, to perform the grinding described above, the occurrence of chatter vibration during grinding can be suppressed. In particular, by using a rotary burr as the rotary grinding tool, the occurrence of chatter vibration during grinding can be more effectively suppressed. By performing processing under optimal conditions, a work-hardened portion formed after notching can be removed while a decrease in tool life and deterioration of grindability caused by clogging and wear of the rotary burr (tool edge) can be reduced. In the disclosed embodiments, by properly performing a grinding process using a rotary grinding tool, such as a rotary burr, it is possible to achieve both efficient removal of a work-hardened portion of a steel strip joint formed by notching and suppression of a decrease in tool life.

### BRIEF DESCRIPTION OF THE DRAWINGS

FIG. 1 is a diagram illustrating an embodiment of a steel strip notching method.

FIG. 2 is a graph showing a distribution of hardness measured in a region from an end portion 3b of a joint in a strip width direction toward a strip widthwise center after notching.

FIG. 3 is a graph showing a distribution of hardness measured in a region from an end portion 3c of the joint in the strip width direction toward the strip widthwise center after grinding using a rotary burr.

FIG. 4 shows a photographic image of an end portion (crack) of a joint in the strip width direction, captured after cold rolling following notching.

FIG. 5 shows a photographic image of an end portion of a joint in the strip width direction, captured after cold rolling preceded by predetermined grinding following notching.

FIG. 6 is an explanatory diagram illustrating a positional relation between a rotary burr and a steel strip in grinding performed using the rotary burr.

FIG. 7 is a lateral view of FIG. 6 when viewed from a side.

FIG. 8 is a top view of FIG. 6 when viewed from above.

FIG. 9 is an explanatory diagram illustrating a grinding method using a rotary burr according to Examples.

FIG. 10 is an explanatory diagram illustrating a grinding method using a rotary burr according to Examples.

FIG. 11 is an explanatory diagram illustrating a grinding method using a rotary burr according to Examples.

### DETAILED DESCRIPTION

Disclosed embodiments will now be described with reference to the drawings. Note that the disclosure is not intended to be limited to the specific embodiments described below.

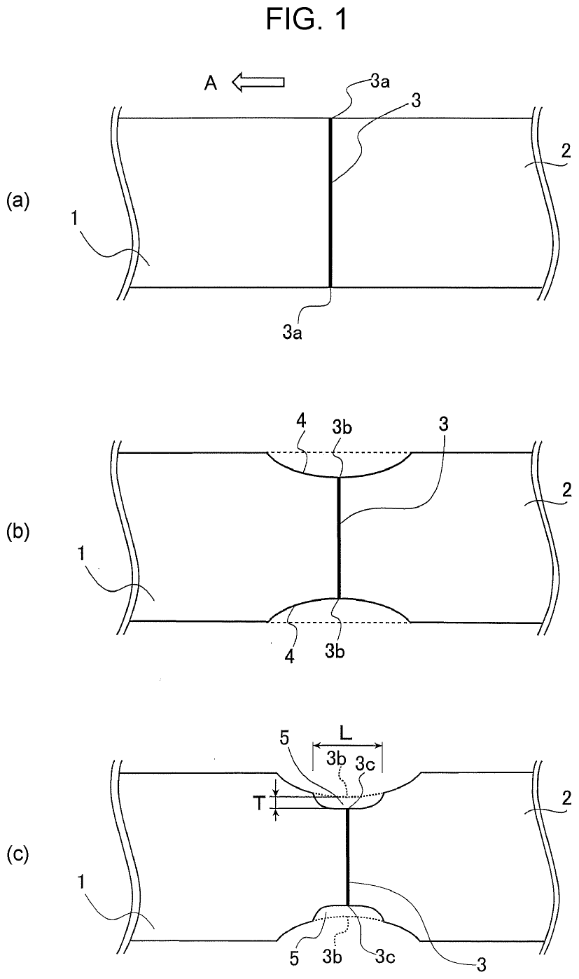

FIG. 1 is a diagram illustrating an embodiment of a steel strip notching method. Arrow A in FIG. 1 indicates the direction in which a steel strip is conveyed.

As illustrated in FIG. 1(a), first, a trailing end of a preceding steel strip 1 is joined to a leading end of a succeeding steel strip 2 by welding. This creates a joint 3. The method of welding the trailing end of the preceding steel strip 1 to the leading end of the succeeding steel strip 2 is not particularly limited. Examples of the method include flash-butt welding and laser welding. Although the preceding steel strip 1 and the succeeding steel strip 2 illustrated in FIG. 1(a) have substantially the same strip width, the configuration is not limited to this and they may have different strip widths. Also, the joining method is not limited to welding and may be, for example, soldering or friction bonding (solid-phase bonding).

As described above, each end portion 3a of the joint 3 in the strip width direction (which may hereinafter be simply referred to as “end portion 3a”) has a widthwise stepped portion formed due to, for example, a difference in strip width or positional displacement between the preceding steel strip 1 and the succeeding steel strip 2. This may cause fracture of the joint 3 during rolling. Accordingly, after the preceding steel strip 1 and the succeeding steel strip 2 are joined by welding to form the joint 3, a notch 4 (cutout 4) is formed at the end portion 3a (FIG. 1(b)). In FIG. 1(b), an empty area inside a dotted line represents a region where the notch 4 is formed. As illustrated in FIG. 1(b), the notch 4 is formed toward the strip widthwise center, in a predetermined region including an end portion of the joint in the strip width direction (widthwise end portion of the joint). Although a substantially semi-elliptical notch is illustrated in FIG. 1(b), the shape of the notch is not particularly limited in the disclosed embodiments.

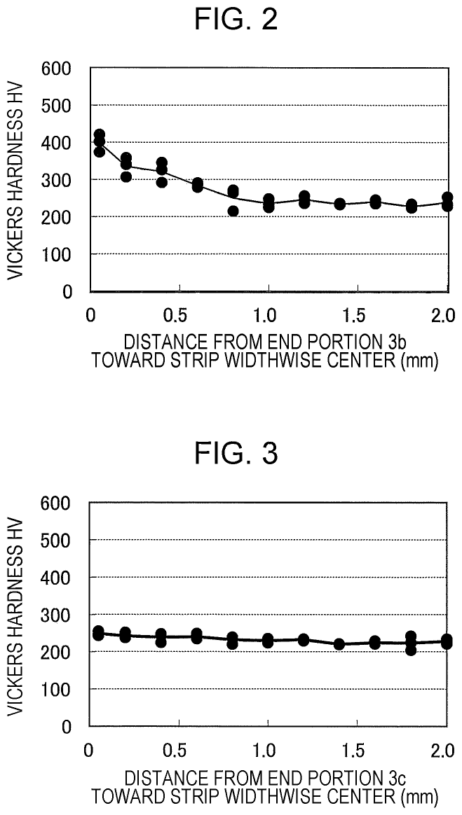

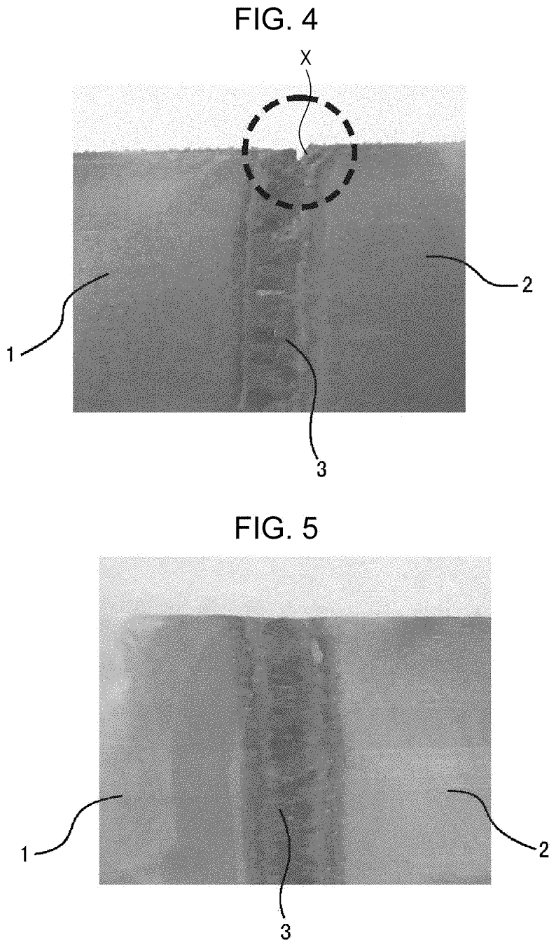

When such a notch is formed at the end portion 3a of the steel strip, work hardening occurs at each end portion 3b of the joint 3 in the strip width direction (which may hereinafter be simply referred to as “end portion 3b”) after the notching. To examine the range of work hardening described above, FIG. 2 shows a distribution of hardness measured in a region from the end portion 3b of the joint 3 toward the strip widthwise center. As shown in FIG. 2, due to work hardening, Vickers hardness is highest at the end portion 3b, and the amount of increase in Vickers hardness decreases in the direction from the end portion 3b toward the strip widthwise center. In the region at a distance of greater than or equal to 1 mm from the end portion 3b toward the strip widthwise center, the Vickers hardness (240 HV) is substantially the same as that at the end portion 3a before notching. That is, FIG. 2 shows that work hardening occurs in the region from the end portion 3b to a point 1 mm away therefrom toward the strip widthwise center. This means that the occurrence of cracks can be prevented by removing the region from the end portion 3b to the point 1 mm away therefrom toward the strip widthwise center.

Accordingly, in the disclosed embodiments, as illustrated in FIG. 1(c), the work-hardened end portion 3b is removed by grinding. In FIG. 1(c), an empty area inside a dotted line represents a ground region 5 removed by grinding. As illustrated in FIG. 1(c), the end portion 3b is removed by grinding toward the strip widthwise center. The range of grinding in the strip longitudinal direction is a portion of the predetermined region of notching. As described above, work hardening occurs in the region from the end portion 3b to the point 1 mm away therefrom toward the strip widthwise center. Therefore, it is preferable that the region from the end portion 3b to the point 1 mm away therefrom toward the strip widthwise center be removed by grinding. However, if a grinding width T (distance from the end portion 3b of the joint 3 toward the strip widthwise center) in the strip width direction is taken too large, the resulting concentration of stress on the cutout portion causes fracture of the joint. Therefore, it is preferable that the grinding width T be less than or equal to 2 mm. For example, the grinding width T is preferably greater than or equal to 0.5 mm. For example, the grinding width T is preferably less than or equal to 2.0 mm. To suppress abrupt changes in strip width, the range of grinding in the strip longitudinal direction, or a grinding length L in FIG. 1(c), is preferably greater than or equal to 8 mm. To improve the suppressing effect on fracture of the joint, the amount of increase in the Vickers hardness of each end portion 3c of the joint 3 in the strip width direction (which may hereinafter be simply referred to as “end portion 3c”) after grinding is preferably less than or equal to 50 HV with respect to the Vickers hardness of the end portion 3a (or Vickers hardness of the base material portion). The grinding width T is appropriately adjusted in accordance with the Vickers hardness of the end portion 3c and the range of work hardening. Note that Vickers hardness in the present description is measured in conformity with JIS Z 2244. Although FIG. 1 shows that part of the region of the notch removed by grinding is a region including the end portion 3b, a notch portion outside the joint may also be cracked for some reason, such as work hardening.

Accordingly, a part of the region of the notch outside the widthwise end portion of the joint may be removed by grinding using the method of the disclosed embodiments.

In the disclosed embodiments, the work-hardened end portion 3b is removed by grinding using a rotary grinding tool. Examples of the rotary grinding tool include, but are not particularly limited to, a rotary burr, a mounted abrasive wheel, a rotary file, a grinder, and a belt sander. It is particularly preferable to use a rotary burr as the rotary grinding tool. The rotary burr is not limited to a particular type. For example, any rotary burr commercially available may be used. Examples of the rotary burr include cutting edges coated with a super hard material, such as tungsten carbide, or diamond abrasive grains, and cutting edges made of high-speed steel (including those coated with Ti or various other materials). It is preferable in the disclosed embodiments to use a cross-cut rotary burr, because of its small cutting resistance and a high suppressing effect on chatter vibration during grinding.

Examples of a preferred rotary burr include a super hard rotary burr and, more specifically, a rotary burr having a cross-cut cylindrical head coated with a super hard material.

If hardness of the steel strip, which is a material to be ground, is high, it is preferable to select a rotary burr with many teeth. The diameter and shape of the rotary burr are not particularly limited, but are preferably set to easily achieve the grinding width T and the grinding length L described above. In the disclosed embodiments, it is preferable to use a rotary burr with a diameter of greater than or equal to 10 mm, which is within the diameter range of commercially available rotary burrs. It is also preferable to use a rotary burr with a diameter of less than or equal to 26 mm. Note that the diameter of a rotary burr refers to the maximum diameter of the rotary burr (cutting edge).

Next, a method of grinding at least part of a region of the notch, using a rotary grinding tool, will be described. As an example, a method of grinding the work-hardened end portion 3b will be described, which involves using a rotary burr as the rotary grinding tool.

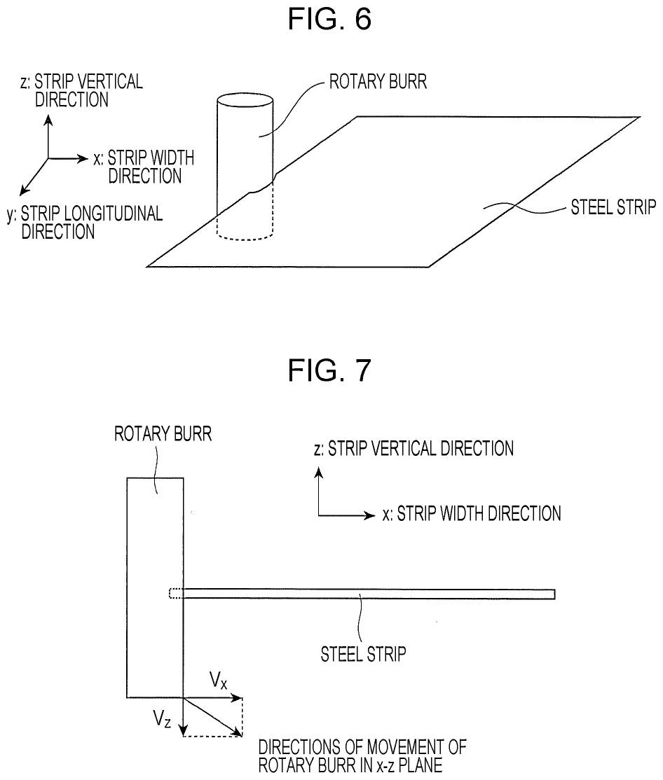

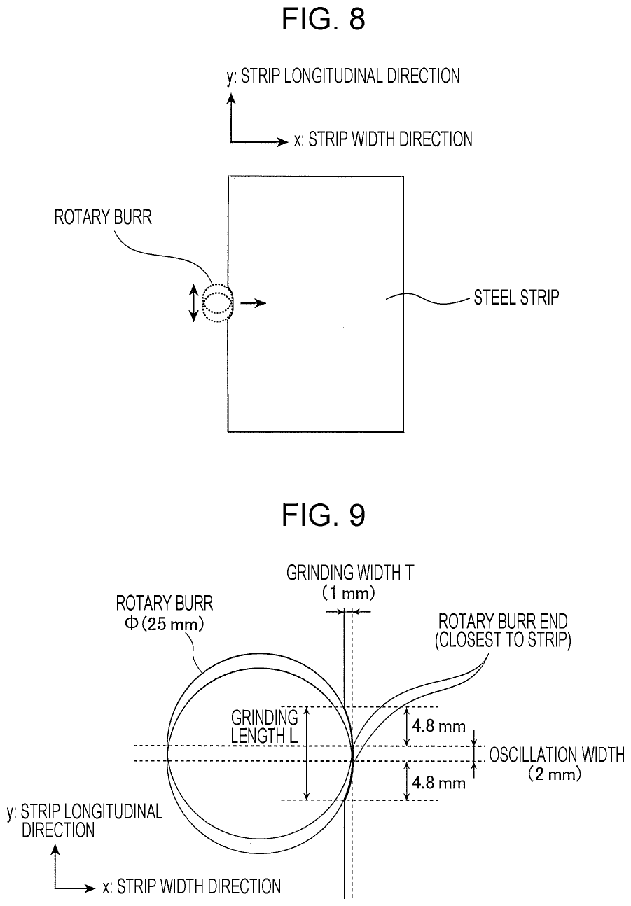

FIG. 6 is an explanatory diagram illustrating a positional relationship between a rotary burr and a steel strip in grinding performed using the rotary burr, FIG. 7 is a lateral view of FIG. 6 when viewed from a side, and FIG. 8 is a top view of FIG. 6 when viewed from above.

A grinding process of the disclosed embodiments involves cutting a widthwise end portion by feeding the rotary burr in the strip width direction (x direction in FIG. 6 to FIG. 8), feeding the rotary burr in the strip vertical direction (z direction in FIG. 6 and FIG. 7) at a feed rate within a predetermined range with respect to a feed rate of the rotary burr in the strip width direction, giving a predetermined feed amount in the strip longitudinal direction (y direction in FIG. 6 and FIG. 8) while feeding the rotary burr by a predetermined feed amount in the strip width direction in parallel with (or simultaneously with) feeding the rotary burr in the strip vertical direction, and cutting the widthwise end portion of the joint while oscillating the rotary burr in the strip longitudinal direction.

The feed rate (cutting speed) of the rotary burr in the strip width direction is preferably greater than or equal to 0.3 mm/sec. Also, the feed rate in the strip width direction is preferably less than or equal to 5.0 mm/sec. When the feed rate in the strip width direction is greater than or equal to 0.3 mm/sec, it is possible to reduce formation of a built-up edge, reduce deterioration of chip discharge performance, and easily suppress deterioration of grindability caused by an increase in heat generation resulting from plastic deformation. Also, when the feed rate in the strip width direction is less than or equal to 5.0 mm/sec, it is easy to suppress an increase in cutting resistance, and to slow down the progress of wear of the tool edge. The number of revolutions of the rotary burr can be set on the basis of a recommended number of revolutions determined by the diameter and shape of the rotary burr.

The rotary burr is fed in the strip width direction to cut the widthwise end portion of the joint, and the rotary burr is also fed in the strip vertical direction at a feed rate within a predetermined range with respect to a feed rate of the rotary burr in the strip width direction. Here, the rotary burr is preferably fed in the strip vertical direction at a feed rate 0.3 to 10.0 times the feed rate of the rotary burr in the strip width direction. This facilitates discharge of chips, prevents use of the same portion of the edge in cutting, and makes it easier to achieve longer life of the tool edge.

In parallel with feeding the rotary burr in the strip vertical direction at the feed rate within the predetermined range with respect to the feed rate of the rotary burr in the strip width direction, a predetermined feed amount is given in the strip longitudinal direction while the rotary burr is fed by a predetermined feed amount in the strip width direction, and the widthwise end portion of the joint is cut while the rotary burr is caused to oscillate (reciprocate) in the strip longitudinal direction. Here, it is preferable to give a feed amount greater than or equal to 5.0% of the rotary burr diameter in the strip longitudinal direction while feeding the rotary burr in the strip width direction by a predetermined feed amount less than or equal to 1.0% of the rotary burr diameter, and also to cause the rotary burr to oscillate (reciprocate) in the strip longitudinal direction. That is, the travel of the rotary burr in the strip longitudinal direction preferably turns before the feed amount of the rotary burr in the strip width direction exceeds 1.0% of the rotary burr diameter. Then, the feed amount (oscillation width) in the strip longitudinal direction from the turning point to the next turning point is preferably greater than or equal to 5.0% of the rotary burr diameter. This contributes to a reduced contact area of the edge with the steel strip and reduces cutting resistance or, in other words, improves a suppressing effect on chatter vibration. If chatter vibration occurs or cutting resistance is too high, the resulting excessive load on a ground portion of the steel strip causes additional work hardening. A decrease in tool life and increased trouble of tool replacement may lead to lower line efficiency. In the disclosed embodiments, by properly carrying out the grinding using the rotary burr, it is possible, without causing additional work hardening, to remove a work-hardened portion formed after notching while reducing a decrease in tool life and deterioration of grindability. The predetermined feed amount in the strip width direction is preferably, but not particularly limited to, greater than or equal to 0.2% of the rotary burr diameter. Also, the feed amount in the strip longitudinal direction is preferably, but not particularly limited to, less than or equal to 300% of the rotary burr diameter.

For grinding a steel strip using a rotary grinding tool, such as a rotary burr, a material to be ground needs to be clamped to prevent the material from moving during the processing. This is done by a technique commonly used in general processing, and the type of clamp is not particularly limited. To easily suppress chatter vibration, the material to be ground is preferably clamped at a position as close as possible to the point of processing. Using cutting oil can reduce cutting resistance and improve grindability. Generally, however, lines in rolling facilities for producing cold-rolled steel strips are rarely in an environment where cutting oil can be used. The use of cutting oil is not specifically defined in the disclosed embodiments. It has been confirmed that the grinding conditions in the disclosed embodiments can provide advantageous effects without using the cutting oil.

FIG. 3 shows a distribution of hardness measured in a region from the end portion 3c (see FIG. 1(c)) of the joint 3 toward the strip widthwise center after grinding performed using the rotary burr. FIG. 3 shows that by properly carrying out grinding, only the work-hardened portion created by forming the notch 4 can be removed without causing additional work hardening.

### EXAMPLES

Effects of the disclosed embodiments were evaluated by producing cold-rolled steel strips (silicon steel sheets). The steel strips used in the evaluation have a Si content of greater than or equal to 3.0% by mass and less than 3.5% by mass, and a sheet thickness of greater than or equal to 1.8 mm and less than or equal to 2.4 mm. The base material portion has a Vickers hardness of about 240 HV. A plurality of steel strips were prepared. As in the embodiments described above, after the trailing end of the preceding steel strip 1 was welded to the leading end of the succeeding steel strip 2, a notch was formed at the resulting end portion 3a of the joint 3. Then, the end portion 3b of the joint 3, which is part of a region of the notch formed after the notching, was ground using a rotary burr under the grinding conditions shown in Table 1.

FIG. 9 to FIG. 11 are explanatory diagrams illustrating a grinding method using a rotary burr according to Examples. The rotary burr used in Examples was a burr (super hard rotary burr) having a diameter of 25 mm, coated with a super hard material (tungsten carbide), and having a cross-cut cylindrical head. The grinding width T was fixed at 1 mm (see FIG. 9). FIG. 9 illustrates an example where the feed amount (oscillation width) of the rotary burr in the strip longitudinal direction is 2 mm (8% of the rotary burr diameter) and the grinding length L is 11.6 mm. In Examples, the grinding was performed with the rotary burr at a rotation speed of 3600 rpm.

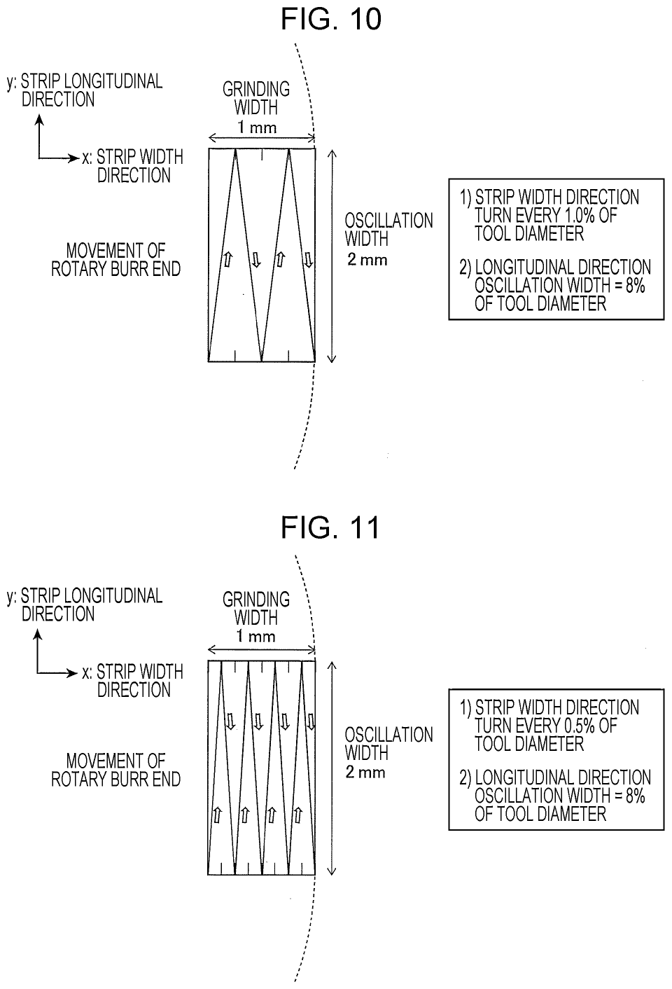

FIG. 10 is an explanatory diagram illustrating the movement of the rotary burr (i.e., movement of the tip of the rotary burr) in the x-y plane under the grinding conditions of Nos. 1, 4, 8, and 9 in Table 1 (shown below). As illustrated in FIG. 10, in these examples, the end portion of the joint in the strip width direction (widthwise end portion of the joint) was cut by giving a feed amount of 2 mm (8% of the rotary burr diameter) in the strip longitudinal direction while at the same time feeding the rotary burr by a feed amount of 0.25 mm (1.0% of the rotary burr diameter) in the strip width direction and oscillating the rotary bur with an oscillation width of 2 mm in the strip longitudinal direction. FIG. 11 is an explanatory diagram illustrating the movement of the rotary burr (i.e., movement of the tip of the rotary burr) in the x-y plane under the grinding conditions of Nos. 5, 10, 11, and 12 in Table 1 (shown below). As illustrated in FIG. 11, in these examples, the end portion of the joint in the strip width direction (widthwise end portion of the joint) was cut by giving a feed amount of 2 mm (8% of the rotary burr diameter) in the strip longitudinal direction while at the same time feeding the rotary burr by a feed amount of 0.125 mm (0.5% of the rotary burr diameter) in the strip width direction and oscillating the rotary burr with an oscillation width of 2 mm in the strip longitudinal direction.

Table 1 shows a result of evaluation made after grinding performed using the rotary burr as described above. Specifically, Table 1 shows evaluation of the ground surface state, the occurrence of chatter vibration, Vickers hardness of the ground end face (end portion 3c) of the steel strip, and whether continuous use is possible. The determination of the occurrence of chatter vibration was made on the basis of the presence of noise and the roughness of the ground surface. The steel strip was then subjected to cold rolling to form a cold-rolled steel strip with a finish thickness of greater than or equal to 0.21 mm and less than 0.25 mm. An overall rating was given to each set of grinding conditions, on the basis of the following criteria. Overall ratings of ⊙, ◯, and Δ are a pass (exhibiting a high suppressing effect on chatter vibration, and capable of reducing a decrease in tool life), whereas an overall rating of x is a fail.

Overall rating ⊙: the amount of increase in Vickers hardness of the widthwise end portion of the joint after grinding, with respect to the Vickers hardness of the base material portion, was less than or equal to 30 HV, and the number of continuous grinding 150 times was possible without causing chatter vibration and spark;

Overall rating ◯: the amount of increase in Vickers hardness of the widthwise end portion of the joint after grinding, with respect to the Vickers hardness of the base material portion, was less than or equal to 30 HV, and the number of continuous grinding 150 times was possible although slight chatter vibration or spark was observed;

Overall rating Δ: the amount of increase in Vickers hardness of the widthwise end portion of the joint after grinding, with respect to the Vickers hardness of the base material portion, was less than or equal to 50 HV, and the number of continuous grinding up to 50 times was possible (i.e., the number of continuous grinding more than 50 times was not possible) although slight spark or increase in heat generation was observed; and

Overall rating x: the number of continuous grinding 50 times was not possible due to, for example, chatter vibration, spark, or chipped edge.

TABLE 1

| | | | Feed | | Ratio | Ratio | | | | | |
|---|---|---|---|---|---|---|---|---|---|---|---|
| | | | Rate | Feed | of Feed | of Feed | | | | | |
| | Feed | Feed | Ratio | Amount | in Strip | in Strip | | | | | |
| | Rate | Rate | (Vertical | in Strip | Width | Longitudinal | Ground | | | | |
| | in Strip | in Strip | Direction/ | Longitudinal | Direction | Direction | Surface | Hardness | | | |
| | Width | Vertical | Strip | Direction | to Tool | to Tool | Finish, | of End | | | |
| | Direction | Direction | Width | (Oscillation | Diameter*¹ | Diameter*² | Chatter | Portion | Other | Overall | |
| No. | (mm/sec) | (mm/sec) | Direction) | Width) | (%) | (%) | Vibration | 3c (HV) | Evaluations | Rating | Remarks |
| 1 | 0.1 | 0.2 | 2.0 | 2 mm | 1.0 | 8.0 | Good | 250 | Continuous | Δ | Example |
| | | | | simultaneously | | | (no chatter | | grinding: | | |
| | | | | with 0.25 mm | | | vibration, no | | 50 times was | | |
| | | | | feed in strip | | | ground | | possible | | |
| | | | | width direction | | | surface | | (continuous | | |
| | | | | | | | roughness) | | grinding | | |
| | | | | | | | | | caused | | |
| | | | | | | | | | more heat | | |
| | | | | | | | | | generation, | | |
| | | | | | | | | | slightly | | |
| | | | | | | | | | reduced | | |
| | | | | | | | | | workability) | | |
| 2 | 0.5 | 0.2 | 0.4 | No feed | — | — | Good | 250 | Continuous | X | Comparative |
| | | | | in strip | | | (no chatter | | grinding: | | Example |
| | | | | longitudinal | | | vibration, no | | less than 50 | | |
| | | | | direction | | | ground | | times was | | |
| | | | | | | | surface | | possible | | |
| | | | | | | | roughness) | | (continuous | | |
| | | | | | | | | | grinding | | |
| | | | | | | | | | caused | | |
| | | | | | | | | | significant | | |
| | | | | | | | | | heat | | |
| | | | | | | | | | generation, | | |
| | | | | | | | | | occurrence | | |
| | | | | | | | | | of spark) | | |
| 3 | 0.5 | 1.0 | 2.0 | No feed | — | — | Chatter | 280 | Continuous | X | Comparative |
| | | | | in strip | | | vibration | | grinding: | | Example |
| | | | | longitudinal | | | | | less than 50 | | |
| | | | | direction | | | | | times was | | |
| | | | | | | | | | possible | | |
| 4 | 0.5 | 1.0 | 2.0 | 2 mm | 1.0 | 8.0 | Good | 250 | Continuous | ⊙ | Example |
| | | | | simultaneously | | | (no chatter | | grinding: | | |
| | | | | with 0.25 mm | | | vibration, no | | 150 | | |
| | | | | feed in strip | | | ground | | times was | | |
| | | | | width direction | | | surface | | possible | | |
| | | | | | | | roughness) | | | | |
| 5 | 0.5 | 1.0 | 2.0 | 2 mm | 0.5 | 8.0 | Good | 250 | Continuous | ⊙ | Example |
| | | | | simultaneously | | | (no chatter | | grinding: | | |
| | | | | with 0.125 mm | | | vibration, no | | 150 | | |
| | | | | feed in strip | | | ground | | times was | | |
| | | | | width direction | | | surface | | possible | | |
| | | | | | | | roughness) | | | | |
| 6 | 0.5 | 1.0 | 2.0 | 1 mm | 1.0 | 4.0 | Slight chatter | 250 | Continuous | ◯ | Example |
| | | | | simultaneously | | | vibration | | grinding: | | |
| | | | | with 0.25 mm | | | | | 150 | | |
| | | | | feed in strip | | | | | times was | | |
| | | | | width direction | | | | | possible | | |
| 7 | 0.5 | 1.0 | 2.0 | 2 mm | 2.0 | 8.0 | Slight chatter | 270 | Continuous | ◯ | Example |
| | | | | simultaneously | | | vibration | | grinding: | | |
| | | | | with 0.5 mm | | | | | 150 | | |
| | | | | feed in strip | | | | | times was | | |
| | | | | width direction | | | | | possible | | |
| | | | | | | | | | (slightly | | |
| | | | | | | | | | decreased | | |
| | | | | | | | | | HV reduction) | | |
| 8 | 0.5 | 6.0 | 12.0 | 2 mm | 1.0 | 8.0 | No chatter | 290 | Continuous | Δ | Example |
| | | | | simultaneously | | | vibration | | grinding: | | |
| | | | | with 0.25 mm | | | (slight burn | | 50 | | |
| | | | | feed in strip | | | in steel strip) | | times was | | |
| | | | | width direction | | | | | possible | | |
| | | | | | | | | | (slightly | | |
| | | | | | | | | | decreased | | |
| | | | | | | | | | HV reduction) | | |
| 9 | 0.5 | No feed | — | 2 mm | 1.0 | 8.0 | Good | 250 | Continuous | X | Comparative |
| | | in strip | | simultaneously | | | (no chatter | | grinding: | | Example |
| | | vertical | | with 0.25 mm | | | vibration, no | | 50 | | |
| | | direction | | feed in strip | | | ground | | times was | | |
| | | | | width direction | | | surface | | possible | | |
| | | | | | | | roughness) | | (continuous | | |
| | | | | | | | | | grinding | | |
| | | | | | | | | | caused | | |
| | | | | | | | | | noticeable | | |
| | | | | | | | | | wear in | | |
| | | | | | | | | | used portion | | |
| | | | | | | | | | of edge and | | |
| | | | | | | | | | occurrence | | |
| | | | | | | | | | of spark) | | |
| 10 | 2.0 | 1.0 | 0.5 | 2 mm | 0.5 | 8.0 | Good | 250 | Continuous | ⊙ | Example |
| | | | | simultaneously | | | (no chatter | | grinding: | | |
| | | | | with 0.125 mm | | | vibration, no | | 150 | | |
| | | | | feed in strip | | | ground | | times was | | |
| | | | | width direction | | | surface | | possible | | |
| | | | | | | | roughness) | | | | |
| 11 | 4.0 | 1.0 | 0.3 | 2 mm | 0.5 | 8.0 | No chatter | 250 | Continuous | ◯ | Example |
| | | | | simultaneously | | | vibration | | grinding: | | |
| | | | | with 0.125 mm | | | (slight burn | | 150 | | |
| | | | | feed in strip | | | in steel strip) | | times was | | |
| | | | | width direction | | | | | possible | | |
| | | | | | | | | | (some | | |
| | | | | | | | | | quenching | | |
| | | | | | | | | | occurred | | |
| | | | | | | | | | but no HV | | |
| | | | | | | | | | problem) | | |
| 12 | 6.0 | 1.0 | 0.2 | 2 mm | 0.5 | 8.0 | No chatter | 290 | Continuous | Δ | Example |
| | | | | simultaneously | | | vibration | | grinding: | | |
| | | | | with 0.125 mm | | | (slight burn | | 50 | | |
| | | | | feed in strip | | | in steel strip) | | times was | | |
| | | | | width direction | | | | | possible | | |
| | | | | | | | | | (slightly | | |
| | | | | | | | | | decreased | | |
| | | | | | | | | | HV reduction) | | |

[Nos. 1 to 12] grinding width T: fixed at 1 mm, diameter of super hard rotary burr: Ø 25 mm, rotation speed of super hard rotary burr: 3600 rpm
*¹(feed amount in strip width direction/diameter of super hard rotary burr) × 100
*²(feed amount in strip longitudinal direction/diameter of super hard rotary burr) × 100

Table 1 shows that when grinding involves feeding the rotary burr in the strip vertical direction while feeding it in the strip width direction and oscillating the rotary burr by feeding it in the strip longitudinal direction and the strip width direction at the same time, deterioration of the ground surface state and significant decrease in tool life are suppressed more effectively than when a process such as that described above is not performed. In particular, if the ratio of the feed rate in the strip vertical direction to the feed rate in the strip width direction, or the ratio of the feed amount (oscillation width) in the strip longitudinal direction to the feed amount in the strip width direction, is within a preferred range of the disclosed embodiments, continuous grinding can be performed through grinding under such conditions, without deteriorating the ground surface state or significantly reducing the tool life. In all Examples, there was no occurrence of cracks at the joint end portion of the cold-rolled steel strip after cold rolling (see FIG. 5) and fracture of the joint during cold rolling was prevented.

Accordingly, by performing the grinding method according to the disclosed embodiments, it is possible to achieve both long tool life and efficient removal of a work-hardened portion of the steel strip.

The disclosed embodiments are applied to silicon steel sheets in Examples, but may be applied to cold-rolled steel strips of other materials.

1. A steel strip notching method comprising:
forming a notch at an end portion of a joint of a steel strip in a strip width direction, the joint being formed by joining a trailing end of a preceding steel strip to a leading end of a succeeding steel strip; and
removing at least part of a region of the notch through grinding by:
cutting the region with a rotary grinding tool by feeding the rotary grinding tool in the strip width direction,
feeding the rotary grinding tool in a strip vertical direction at a feed rate within a predetermined range with respect to a feed rate of the rotary grinding tool in the strip width direction,
giving a predetermined feed amount in a strip longitudinal direction while feeding the rotary grinding tool by a predetermined feed amount in the strip width direction simultaneously with feeding the rotary grinding tool in the strip vertical direction, and
cutting the region while oscillating the rotary grinding tool in the strip longitudinal direction.

2. The steel strip notching method according to claim 1, wherein the rotary grinding tool is a rotary burr, and the rotary burr is fed in the strip vertical direction at a feed rate in a range of 0.3 to 10.0 times a feed rate of the rotary burr in the strip width direction.

3. The steel strip notching method according to claim 1, wherein the rotary grinding tool is a rotary burr, and a feed amount greater than or equal to 5.0% of a diameter of the rotary burr is given in the strip longitudinal direction while the rotary burr is fed in the strip width direction by the predetermined feed amount, the predetermined feed amount being less than or equal to 1.0% of the diameter of the rotary burr.

4. A cold rolling method comprising cold rolling a steel strip notched by the steel strip notching method according to claim 1.

5. A method for producing a cold-rolled steel strip, the method comprising forming a cold-rolled steel strip by using the cold rolling method according to claim 4.

6. The steel strip notching method according to claim 2, wherein a feed amount greater than or equal to 5.0% of a diameter of the rotary burr is given in the strip longitudinal direction while the rotary burr is fed in the strip width direction by the predetermined feed amount, the predetermined feed amount being less than or equal to 1.0% of the diameter of the rotary burr.

7. A cold rolling method comprising cold rolling a steel strip notched by the steel strip notching method according to claim 2.

8. A cold rolling method comprising cold rolling a steel strip notched by the steel strip notching method according to claim 3.

9. A cold rolling method comprising cold rolling a steel strip notched by the steel strip notching method according to claim 6.

10. A method for producing a cold-rolled steel strip, the method comprising forming a cold-rolled steel strip by using the cold rolling method according to claim 7.

11. A method for producing a cold-rolled steel strip, the method comprising forming a cold-rolled steel strip by using the cold rolling method according to claim 8.

12. A method for producing a cold-rolled steel strip, the method comprising forming a cold-rolled steel strip by using the cold rolling method according to claim 7.
